(19) United States
(12) Patent Application Publication
(10) Pub. No.: US 2020/0386588 A1
(43) Pub. Date: Dec. 10, 2020

(54) OPTICAL INSPECTION APPARATUS AND OPTICAL INSPECTION METHOD

(71) Applicants: HKC CORPORATION LIMITED, Shenzhen, Guangdong (CN); CHONGQING HKC OPTOELECTRONICS TECHNOLOGY CO., LTD., Chongqing (CN)

(72) Inventor: Kunyuan LEE, Chongqing (CN)

(73) Assignees: HKC Corporation Limited, Shenzhen, Guangdong (CN); Chongqing HKC Optoelectronics Tecnology Co., Ltd., Chongqing (CN)

(21) Appl. No.: 16/634,806

(22) PCT Filed: Aug. 31, 2017
(86) PCT No.: PCT/CN2017/099858

§ 371 Date: Jan. 28, 2020

(30) Foreign Application Priority Data
Aug. 2, 2017 (CN) 201710654053.9

(51) Int. Cl. G01D 21/02; G01B 11/14; G01P 13/00

(52) U.S. Cl. CPC G01D 21/02; G01P 13/00; G01B 11/14

(57) ABSTRACT

An optical inspection apparatus and an optical inspection method are provided. The optical inspection apparatus includes: a first detection device including a first display device and a first control device connected to the first display device for controlling a state of the first display device; a second detection device including a second display device and a second control device connected to the second display device for controlling a state of the second display device, wherein the first display device and the second display device are disposed opposite each other; and a sensing device disposed between the first detection device and the second detection device for sensing a target position movement and sending a signal to the first control device and the second control device. The optical inspection apparatus can decrease the staffing, avoid a lot of movement consumption, and automatically switch the light sources to decrease the detection interference.

### BACKGROUND

### Technology Field

This disclosure relates to an optical detection field, and more particularly to an optical inspection apparatus and an optical inspection method.

### Description of Related Art

Conventionally, one single staff corresponds to one optical macroscopic inspection apparatus. Such the method may be understood as one staff corresponding to one machine. However, because the ratio of the staffs inspection time to the time for unloading, loading and positioning the pieces on the apparatus approaches 1:1, this means that the one half of the staffs time is the waiting time, and the staff cannot perform the inspection process in the waiting time, thereby wasting the staffs time. Typically, apparatuses are arranged in parallel in order to overcome such the problem. Because the staff moves at the middle therebetween, such the movement time consumption is still caused. Thereafter, two apparatuses are disposed in a mirrored manner to decrease the staffs movement time loss. However, the light sources of such the two opposite apparatuses interfere with each other, thereby affecting the detection result. Meanwhile, the time utilization also may be improved.

### SUMMARY

A main objective of this disclosure is to provide an optical inspection apparatus to solve the existing problems of the staffing waste of the macroscopic inspection and the low efficiency.

An objective of this disclosure is achieved by providing an optical inspection apparatus, comprising a first detection device, a second detection device, and a sensing device. The first detection device comprises a first display device and a first control device, wherein the first control device is connected to the first display device and is configured to control a state of the first display device; the second detection device comprises a second display device and a second control device, wherein the second control device is connected to the second display device, and is configured to control a state of the second display device, wherein the first display device and the second display device are disposed opposite each other; the sensing device senses a target position movement and sends a signal to the first control device and the second control device, wherein the sensing device is disposed between the first detection device and the second detection device.

Optionally, the sensing device comprises a first sensor connected to the first control device and a second sensor connected to the second control device.

Optionally, the first sensor and the second sensor are disposed symmetrically, the first sensor is disposed on one side close to the first detection device, and the second sensor is disposed on one side close to the second detection device.

Optionally, the first sensor and the second sensor are signal-connected to each other.

Optionally, the first detection device further comprises a first interrupter connected to the first sensor, the second detection device further comprises a second interrupter connected to the second sensor, and the first interrupter and the second interrupter respectively turn off or on the light source of the first detection device or the second detection device according to the movement position of a target sensed by the first sensor and the second sensor.

Optionally, the first interrupter comprises a signal receiver for receiving a sensing signal of the first sensor, and the second interrupter also comprises a signal receiver for receiving a sensing signal of the second sensor.

Optionally, the first detection device and the second detection device are disposed separately and in parallel.

Optionally, sensing the target position movement is sensing a staff position movement or a robot position movement.

Optionally, the first detection device and the second detection device are disposed symmetrically and in a mirrored manner.

Optionally, the first detection device and the second detection device perform an optical detection on a display panel.

An objective of this disclosure is also achieved by providing an optical inspection method, comprising the following steps: receiving a target position signal sent from a sensing device; and controlling on and off states of the light sources in a first detection device and a second detection device according to the received target position signal sent from the sensing device.

Optionally, the step of controlling the on and off states of the light sources in the first detection device and the second detection device according to the received target position signal sent from the sensing device comprises the following steps: judging whether a target is at a position close to the second detection device, when the target is at the position close to the second detection device, the light source of the first detection device is controlled to turn off, and the light source of the second detection device is controlled to turn on; and judging whether the target is at the position close to the first detection device, when the target is at the position close to the first detection device, the light source of the second detection device is controlled to turn off, and the light source of the first detection device is controlled to turn on.

An objective of this disclosure is also achieved by providing an optical inspection apparatus, comprising a first detection device, a second detection device, and a sensing device. The first detection device comprises a first display device and a first control device, wherein the first control device is connected to the first display device and is configured to control a state of the first display device; the second detection device comprises a second display device and a second control device, wherein the second control device is connected to the second display device, and is configured to control a state of the second display device, wherein the first display device and the second display device are disposed opposite each other; and the sensing device senses a target position movement and sends a signal to the first control device and the second control device, wherein the sensing device is disposed on a symmetrical line of the first detection device and the second detection device; the optical inspection apparatus further comprises a lifting device disposed between the first detection device and the second detection device, and the sensing device is disposed on the lifting device to adjust the disposed height of the sensing device.

In the technical solution of this disclosure, the first display device and the second display device are disposed opposite each other in the optical inspection apparatus, so that when the user performs the optical detection, the user only needs to move by a short distance to save the time, and the user can operate the first detection device and the second detection device concurrently. Meanwhile, the sensing device is disposed between the first detection device and the second detection device to sense the positional movement of the user when the user is operating the optical macroscopic inspection apparatus, thereby controlling the on and off states of the light sources of the first detection device and the second detection device according to the user's movement position.

The optical inspection apparatus of this disclosure can decrease the staffing, avoid a lot of movement consumption, and automatically switch the light sources to decrease the detection interference.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is a schematic structure view showing an optical inspection apparatus in an embodiment of this disclosure;

FIG. 2 is a schematic flow chart showing an optical inspection method in an embodiment of this disclosure;

FIG. 3 is a schematic flow chart showing an optical inspection method in another embodiment of this disclosure;

FIG. 4 is a schematic view showing modules of an optical inspection system in an embodiment of this disclosure;

FIG. 5 is a schematic view showing modules of an optical inspection system in another embodiment of this disclosure; and

FIG. 6 is a modular diagram showing an optical inspection apparatus in an embodiment of this disclosure.

The implementation, functional characteristics and advantages of this disclosure will be further described with reference to the accompanying drawings.

### DETAILED DESCRIPTION OF THE DISCLOSURE

Specific structures and function details disclosed herein are only for the illustrative purpose for describing the exemplary embodiment of this disclosure. However, this disclosure can be specifically implemented through many replacements, and should not be explained as being restricted to only the embodiment disclosed herein.

In the description of this disclosure, it is to be understood that the terms “center”, “transversal”, “up”, “down”, “left”, “right”, “vertical”, “horizontal”, “top”, “bottom”, “inside” and “outside” indicating the orientation or position relationships are the orientation or position relationships based on the drawing, are only provided for the purposes of describing this disclosure and simplifying the description, but do not indicate or imply that the directed devices or elements must have the specific orientations or be constructed and operated in the specific orientations, and thus cannot be understood as the restriction to this disclosure. In addition, the terms “first”, and “second” are used for the illustrative purpose only and cannot be understood as indicating or implying the relative importance or implicitly specifying the number of indicated technical features. Therefore, the features restricted by “first” and “second” may expressly or implicitly comprise one or multiple ones of the features. In the description of this disclosure, unless otherwise described, the meaning of “multiple” comprises two or more than two. In addition, the terms “comprises” and any modification thereof intend to cover the non-exclusive inclusions.

In the description of this disclosure, it needs to be described that, unless otherwise expressly stated and limited, the terms “mount”, “link” and “connect” should be broadly understood. For example, they may be the fixed connection, may be the detachable connection or may be the integral connection; may be the mechanical connection or may also be the electrical connection; or may be the direct connection, may be the indirect connection through a middle medium or may be the inner communication between two elements. It will be apparent to those skilled in the art that the specific meanings of the above terms in this application may be understood according to the specific conditions.

The terms used herein are for the purpose of describing only specific embodiments and are not intended to limit the exemplary embodiments. Unless the contexts clearly indicate otherwise, the singular form “one”, “a” and “an” used here further intend to include plural forms. It should also be understood that the terms “comprising” and/or “including” are used herein to describe the features to describe the presence of stated features, integers, steps, operations, units and/or elements without excluding the presence or addition of one or more other features, integers, steps, operations, units, elements, and/or combinations thereof.

This disclosure provides an optical inspection apparatus to solve the existing problems of the staffing waste of the macroscopic inspection and the low efficiency.

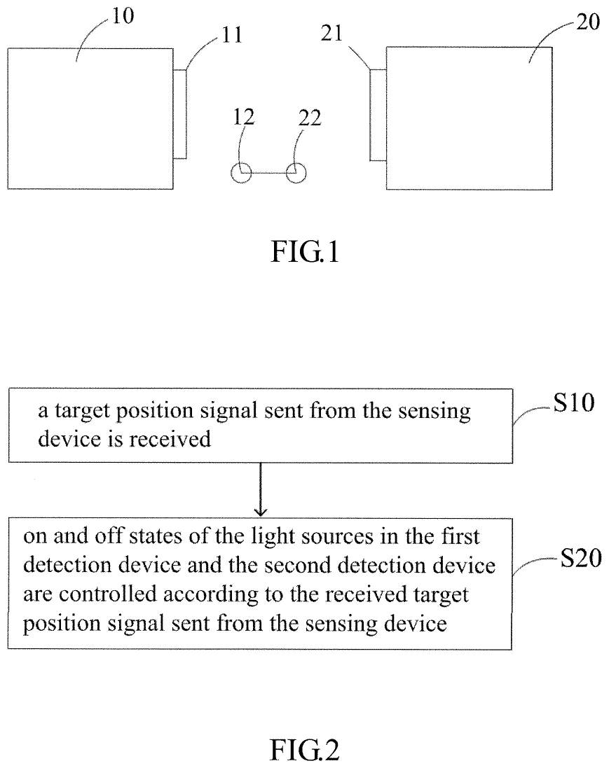

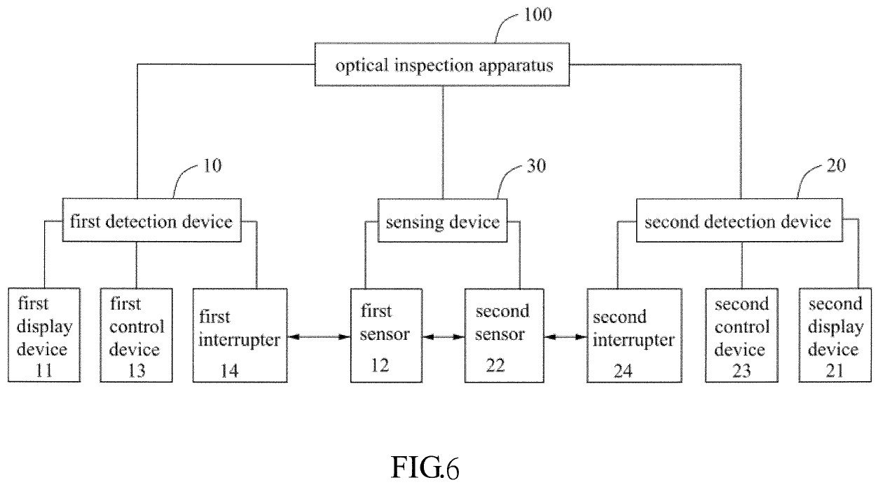

Referring to FIGS. 1 and 6, in one embodiment of this disclosure, the optical inspection apparatus 100 includes a first detection device 10, a second detection device 20 and a sensing device 30.

The first detection device 10 includes a first display device 11 and a first control device 13, the first control device 13 is connected to the first display device 11, and the first control device 13 controls a state of the first display device 11.

The second detection device 20 includes a second display device 21 and a second control device 23, the second control device 23 is connected to the second display device 21, and the second control device 23 controls a state of the second display device 21.

The first display device 11 and the second display device 21 are disposed opposite each other.

The sensing device 30 senses a target position movement and sends the signal to the first control device 13 and the second control device 23, and the sensing device 30 is disposed between the first detection device 10 and the second detection device 20.

In this embodiment, the first display device 11 and the second display device 21 in the optical inspection apparatus are disposed opposite each other. That is, the first detection device 10 and the second detection device 20 are disposed separately and in parallel. Such the design enables the staff to monitor two detection devices with the short moving distance upon performing the optical detection, thereby taking the advantage of the time of the staff for waiting the ready operation of the machine. Meanwhile, because the optical detection device outputs a lot of light, each of the two machines outputs a lot of light to cause the interference on the detections of both of them when the first detection device 10 and the second detection device 20 work concurrently. In order to avoid such the condition, the optical inspection apparatus 100 of this embodiment further includes the sensing device 30 for sensing a target position movement and sending the signal to the control device. The sensing device 30 is disposed between the first detection device 10 and the second detection device 20. When the sensing device 30 senses that the staff moves from the first detection device 10 to the second detection device 20 or senses that the staff is closer to one of the detection devices, the sensing device 30 may send the signal to the control device. The control device further controls the light source of the first detection device 10 to turn off and controls the light source of the second detection device 20 to turn on according to the signal, thereby preventing the light of the first detection device 10 from interfering the detection when the staff moves from the first detection device 10 to the second detection device 20 to perform the optical detection. The optical macroscopic detection apparatus adopting this embodiment effectively decreases the staffing, avoids a lot of movement consumption, and can automatically switch the light source to decrease the detection interference.

Of course, in another embodiment, the optical detection may also be implemented through a smart robot. At this time, the sensing device senses the target position movement, specifically the movement of the robot.

Optionally, the sensing device 30 is a position sensing device. By sensing the movement position of the staff and judging the movement direction of the staff, it is possible to judge whether the staff moves from the first detection device 10 to the second detection device 20 or from the second detection device 20 to the first detection device 10 according to the movement direction of the staff. Alternatively, in another embodiment, by sensing which one of the detection devices is specifically closer to the staff, the light source of the detection device is controlled to turn on or off.

As a preferred aspect of the previous embodiment, the sensing device includes a first sensor 12 connected to the control device of the first detection device 10 and a second sensor 22 connected to the control device of the second detection device 20. By configuring two sensors respectively sending the sensed signals to the first control device and the second control device, the signal sending and receiving are respectively finished on the two sensors and the two control devices, thereby enhancing the sensing and analyzing efficiency.

Further, the first sensor 12 and the second sensor 22 are disposed symmetrically, the first sensor 12 is disposed on one side close to the first detection device 10, and the second sensor 22 is disposed on one side close to the second detection device 20. Disposing the first sensor 12 and the second sensor 22 symmetrically can achieve the beauty of the structure. In addition, the first sensor 12 is connected to the first detection device 10, and the second sensor 22 is connected to the second detection device 20, so the first sensor 12 and the second sensor 22 sense the order of the staff position movements or the specific position of the staff to determine whether the light sources of the first detection device 10 and the second detection device 20 are turned on or off. Thus, the first sensor 12 and the second sensor 22 are respectively disposed on two sides in this embodiment.

Optionally, the first sensor 12 and the second sensor 22 are signal-connected to each other in this embodiment so that the first sensor 12 and the second sensor 22 can transmit signals therebetween.

Optionally, the first detection device 10 further includes a first interrupter 14 connected to the first sensor 12, and the second detection device 20 further includes a second interrupter 24 connected to the second sensor 22. The first interrupter 14 and the second interrupter 24 respectively turn off or on the light source of the first detection device 10 or the second detection device 20 according to the movement position of the staff sensed by the first sensor 12 and the second sensor 22 or the staffs final position. In this embodiment, the first detection device 10 and the second detection device 20 are respectively provided with the first interrupter 14 and the second interrupter 24, and the first interrupter 14 and the second interrupter 24 turn off or on the light source. When the first sensor 12 sends the sensed staffs movement signal to the first interrupter 14, the second sensor 22 sends the sensed staffs movement signal to the second interrupter 24 and the sensed signal of the first sensor 12 is before that of the second sensor 22, the first interrupter 14 turns off the light source of the first detection device 10, and the second interrupter 24 does not operate.

As an optional aspect of the previous embodiment, the first interrupter 14 includes a signal receiver for receiving the sensing signal of the first sensor 12, and the second interrupter 24 also includes a signal receiver for receiving the sensing signal of the second sensor 22. The signal receivers for receiving the signals are disposed in the first interrupter 14 and the second interrupter 24 to receive the signals sent from the first sensor 12 and the second sensor 22.

Optionally, the first detection device 10 and the second detection device 20 are disposed symmetrically and in a mirrored manner, so that the staff can operate the two detection devices concurrently when the staff is performing the optical detection. When the operation of the first detection device 10 is ready, the staff may move to the second detection device 20 to operate the second detection device 20, thereby taking the advantage of the staffs waiting time, and enhancing the work efficiency. Meanwhile, one staff can operate two machines so that the staffing is decreased. In addition, the sensing device 30 is disposed on a symmetrical line of the first detection device 10 and the second detection device 20, so that the gaps between the sensing device 30 and both of the first detection device 10 and the second detection device 20 are the same to decrease the deviations brought by the different distances between the sensing device 30 and the two detection devices on two sides.

In addition, the optical inspection apparatus further includes a lifting device (not shown) disposed between the first detection device and the second detection device. The sensing device is disposed on the lifting device to adjust the disposed height of the sensing device. Using the lifting device to adjust the height of the sensing device can adjust the height of the sensing device according to the heights of different detection staffs, thereby enhancing the sensitivity of the sensing device for sensing the staffs position.

This disclosure further discloses an optical inspection method. Referring to FIG. 2, the optical inspection method includes the following steps.

In a step S10, a target position signal sent from the sensing device 30 is received.

In a step S20, on and off states of the light sources in the first detection device 10 and the second detection device 20 are controlled according to the received target position signal sent from the sensing device.

In this embodiment, the control devices in the first detection device 10 and the second detection device 20 receive the staffs position signal sent from the sensing device 30. For example, when the staff is at the first detection device 10, the control device controls the light source of the first detection device 10 to turn on, and controls the light source of the second detection device 20 to turn off and when the staff is at the second detection device 20, the control device controls the light source of the first detection device 10 to turn off, and controls the light source of the second detection device 20 to turn on.

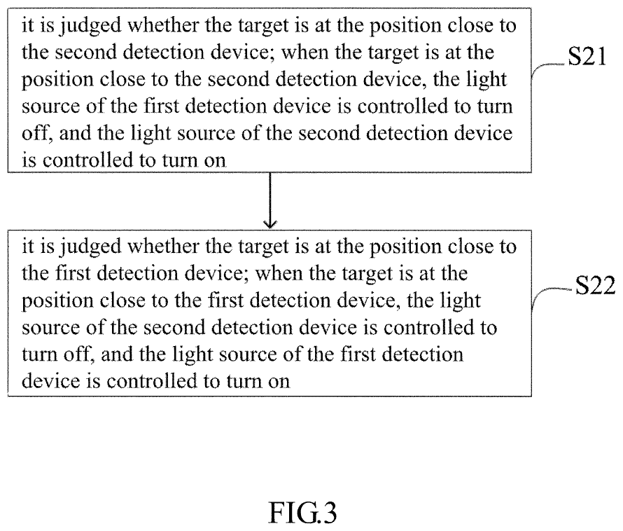

Referring to FIG. 3, the step of controlling the on and off states of the light sources in the first detection device 10 and the second detection device 20 according to the received user's position signal includes the following steps.

In a step S21, it is judged whether the target is at the position close to the second detection device 20. When the target user is at the position close to the second detection device 20, the light source of the first detection device 10 is controlled to turn off, and the light source of the second detection device 20 is controlled to turn on.

In a step S22, it is judged whether the target is at the position close to the first detection device 10. When the target user is at the position close to the first detection device 10, the light source of the second detection device 20 is controlled to turn off, and the light source of the first detection device 10 is controlled to turn on.

Specifically, when the light sources of the first detection device 10 and the second detection device 20 are controlled, it is judged whether the user is at the first detection device 10 or the second detection device 20 mainly through the user's movement position, and the on and off states of the light sources of the first detection device 10 and the second detection device 20 are thus controlled according to the staffs position.

When the sensing device 30 includes the first sensor 12 and the second sensor 22, the light sources of the first detection device 10 and the second detection device 20 are controlled according to the order of the sensing signals received by the control device. For example, when the first sensor 12 firstly receives the staffs position signal, the first sensor 12 firstly sends the control device or the first interrupter of the first detection device 10, and the control device controls the light source of the first detection device 10 to turn on, and controls the light source of the second detection device 20 to turn off. When the second sensor 22 receives the staffs position signal, the second sensor 22 sends the signal to the control device or the second interrupter of the second detection device 20, and the control device controls the light source of the second detection device 20 to turn on, and controls the light source of the first detection device 10 to turn off. Such the control method is adopted to prevent the two detection devices from interfering with each other in the detection process.

Specifically, when being applied to the display panel production and the optical detections are performed on the display panels, the prepared display panels are mounted in the optical detection devices, and the user operates in front of the optical detection devices. The two opposite optical detection device are mounted with the to-be-detected display panels, and the user configures the parameters of the first detection device 10. At this time, the light source of the first detection device 10 is turned on to facilitate the user's configuration. After the configuration work of the first detection device 10 is ready, the second detection device 20 is configured. At this time, the user moves from the position of the first detection device 10 to the second detection device 20, and the first sensor 12 and the second sensor 22 sense the user's position information. When the first sensor senses the user's position, it shows that the user is located on one side of the first detection device 10 at this time. At this time, the second sensor 22 sends the signal to the second control device to control the light source of the second detection device 20 to turn off. When the user moves to one side of the second detection device 20, the second sensor 22 senses the user's position information. At this time, the first sensor 12 sends the signal to the first control device of the first detection device 10, and thus controls the light source of the first detection device to turn off. The user further configures the parameters of the second detection device 20, so that the second detection device 20 performs the optical detection on the display panel at the same time.

Specifically, the display panel may be an LCD display panel, an OLED display panel, a QLED display panel, a curved display panel, or other display panels.

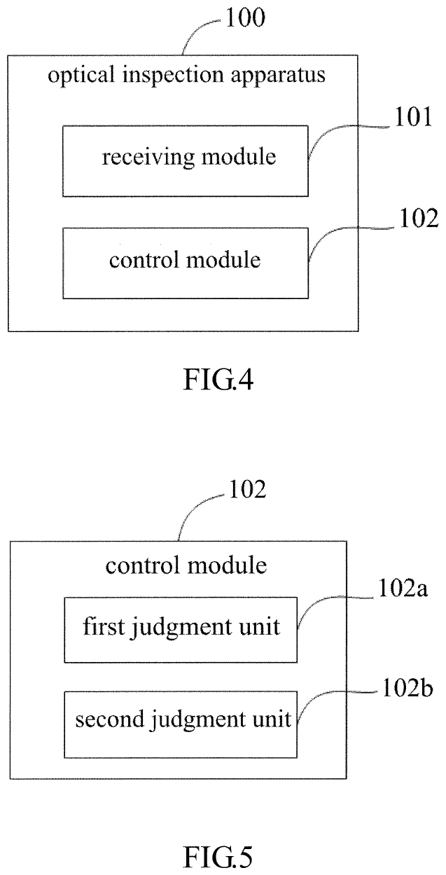

Referring to FIG. 4, the optical inspection apparatus 100 of this disclosure includes a receiving module 101 and a control module 102.

The receiving module 101 receives a target position signal sent from the sensing device 30.

The control module 102 controls the on and off states of the light sources in the first detection device 10 and the second detection device 20 according to the received target position signal.

In this embodiment, both of the receiving module 101 and the control module 102 are disposed in the first detection device 10 and the second detection device 20. The control modules 102 in the first detection device 10 and the second detection device 20 receive the staffs position signal sent from the sensing device 30. For example, when the staff is at the first detection device 10, the control module 102 controls the light source of the first detection device 10 to turn on, and controls the light source of the second detection device 20 to turn off. When the staff is at the second detection device 20, the control module 102 controls the light source of the first detection device 10 to turn off, and controls the light source of the second detection device 20 to turn on.

Further, referring to FIG. 5, the control module 102 includes a first judgment unit 102a and a second judgment unit 102b.

The first judgment unit 102a judges whether the target is at the position close to the second detection device 20. When the target user is at the position close to the second detection device 20, the light source of the first detection device 10 is controlled to turn off, and the light source of the second detection device 20 is controlled to turn on.

The second judgment unit 102b judges whether the target is at the position close to the first detection device 10. When the target user is at the position close to the first detection device 10, the light source of the second detection device 20 is controlled to turn off, and the light source of the first detection device 10 is controlled to turn on.

Specifically, when the light sources of the first detection device 10 and the second detection device 20 are controlled, it is judged whether the user is at the first detection device 10 or the second detection device 20 mainly through the user's movement position, and the on and off states of the light sources of the first detection device 10 and the second detection device 20 are thus controlled according to the staffs position.

When the sensing device 30 includes the first sensor 12 and the second sensor 22, the light sources of the first detection device 10 and the second detection device 20 are controlled according to the order of the sensing signals received by the control device. For example, when the first sensor 12 firstly receives the staffs position signal, the first sensor 12 firstly sends the control device or the first interrupter of the first detection device 10, and the control device controls the light source of the first detection device 10 to turn on, and controls the light source of the second detection device 20 to turn off. When the second sensor 22 receives the staffs position signal, the second sensor 22 sends the signal to the control device or the second interrupter of the second detection device 20, and the control module 102 controls the light source of the second detection device 20 to turn on, and controls the light source of the first detection device 10 to turn off. Such the control method is adopted to prevent the two detection devices from interfering with each other in the detection process.

The optical inspection apparatus 100 of this disclosure may be used to detect various electronic devices including, for example but without limitation to, display devices. When being applied to the detection of the display devices, the display panels may be detected.

Specifically, when being applied to the display panel production and the optical detections are performed on the display panels, the prepared display panels are mounted in the optical detection devices, and the user operates in front of the optical detection devices. The two opposite optical detection device are mounted with the to-be-detected display panels, and the user configures the parameters of the first detection device 10. At this time, the light source of the first detection device 10 is turned on to facilitate the user's configuration. After the configuration work of the first detection device 10 is ready, the second detection device 20 is configured. At this time, the user moves from the position of the first detection device 10 to the second detection device 20, and the first sensor 12 and the second sensor 22 sense the user's position information. When the first sensor senses the user's position, it shows that the user is located on one side of the first detection device 10 at this time. At this time, the second sensor 22 sends the signal to the second control device 23 to control the light source of the second detection device 20 to turn off. When the user moves to one side of the second detection device 20, the second sensor 22 senses the user's position information. At this time, the first sensor 12 sends the signal to the first control device 13 of the first detection device 10, and thus controls the light source of the first detection device to turn off. The user further configures the parameters of the second detection device 20, so that the second detection device 20 performs the optical detection on the display panel at the same time.

Specifically, the display panel may be an LCD display panel, an OLED display panel, a QLED display panel, a curved display panel, or other display panels.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. An optical inspection apparatus, comprising:
a first detection device comprising a first display device and a first control device, wherein the first control device is connected to the first display device and is configured to control a state of the first display device;
a second detection device comprising a second display device and a second control device, wherein the second control device is connected to the second display device, and is configured to control a state of the second display device, wherein the first display device and the second display device are disposed opposite each other; and
a sensing device configured to sense a target position movement and sending a signal to the first control device and the second control device, wherein the sensing device is disposed between the first detection device and the second detection device.

2. The optical inspection apparatus according to claim 1, wherein the sensing device comprises a first sensor connected to the first control device and a second sensor connected to the second control device.

3. The optical inspection apparatus according to claim 2, wherein the first sensor and the second sensor are disposed symmetrically, the first sensor is disposed on one side close to the first detection device, and the second sensor is disposed on one side close to the second detection device.

4. The optical inspection apparatus according to claim 2, wherein the first sensor and the second sensor are signal-connected to each other.

5. The optical inspection apparatus according to claim 2, wherein the first detection device further comprises a first interrupter connected to the first sensor, the second detection device further comprises a second interrupter connected to the second sensor, and the first interrupter and the second interrupter respectively turn off or on the light source of the first detection device or the second detection device according to the movement position of a target sensed by the first sensor and the second sensor.

6. The optical inspection apparatus according to claim 5, wherein the first interrupter comprises a signal receiver for receiving a sensing signal of the first sensor, and the second interrupter also comprises a signal receiver for receiving a sensing signal of the second sensor.

7. The optical inspection apparatus according to claim 1, wherein the first detection device and the second detection device are disposed separately and in parallel.

8. The optical inspection apparatus according to claim 1, wherein sensing the target position movement is sensing a staff position movement or a robot position movement.

9. The optical inspection apparatus according to claim 1, wherein the first detection device and the second detection device are disposed symmetrically and in a mirrored manner.

10. The optical inspection apparatus according to claim 9, wherein the first detection device and the second detection device perform an optical detection on a display panel.

11. An optical inspection method, comprising the following steps:
receiving a target position signal sent from a sensing device; and
controlling on and off states of the light sources in a first detection device and a second detection device according to the received target position signal sent from the sensing device.

12. The method according to claim 11, wherein the step of controlling the on and off states of the light sources in the first detection device and the second detection device according to the received target position signal sent from the sensing device comprises the following steps:
judging whether a target is at a position close to the second detection device, when the target is at the position close to the second detection device, the light source of the first detection device is controlled to turn off, and the light source of the second detection device is controlled to turn on; and
judging whether the target is at the position close to the first detection device, when the target is at the position close to the first detection device, the light source of the second detection device is controlled to turn off, and the light source of the first detection device is controlled to turn on.

13. An optical inspection apparatus, comprising:
a first detection device comprising a first display device and a first control device, wherein the first control device is connected to the first display device and is configured to control a state of the first display device;
a second detection device comprising a second display device and a second control device, wherein the second control device is connected to the second display device, and is configured to control a state of the second display device, wherein the first display device and the second display device are disposed opposite each other; and
a sensing device configured to sense a target position movement and sending a signal to the first control device and the second control device, wherein the sensing device is disposed on a symmetrical line of the first detection device and the second detection device;
the optical inspection apparatus further comprises a lifting device disposed between the first detection device and the second detection device, and the sensing device is disposed on the lifting device to adjust the disposed height of the sensing device.

14. The optical inspection apparatus according to claim 13, wherein the sensing device comprises a first sensor connected to the first control device and a second sensor connected to the second control device.

15. The optical inspection apparatus according to claim 14, wherein the first sensor and the second sensor are disposed symmetrically, the first sensor is disposed on one side close to the first detection device, and the second sensor is disposed on one side close to the second detection device.

16. The optical inspection apparatus according to claim 14, wherein the first sensor and the second sensor are signal-connected to each other.

17. The optical inspection apparatus according to claim 14, wherein the first detection device further comprises a first interrupter connected to the first sensor, the second detection device further comprises a second interrupter connected to the second sensor, and the first interrupter and the second interrupter respectively turn off or on the light source of the first detection device or the second detection device according to the movement position of a target sensed by the first sensor and the second sensor.

18. The optical inspection apparatus according to claim 17, wherein the first interrupter comprises a signal receiver for receiving a sensing signal of the first sensor, and the second interrupter also comprises a signal receiver for receiving a sensing signal of the second sensor.

19. The optical inspection apparatus according to claim 13, wherein the first detection device and the second detection device are disposed symmetrically and in a mirrored manner.

20. The optical inspection apparatus according to claim 19, wherein the first detection device and the second detection device perform an optical detection on a display panel.
